(19) United States
(12) Patent Application Publication
(10) Pub. No.: US 2003/0009342 A1
(43) Pub. Date: Jan. 9, 2003

(54) Software that converts text-to-speech in any language and shows related multimedia

(76) Inventor: Mark R. Haley, Garland, TX (US)

Correspondence Address: Mark Haley, 1814 Creekway Drive, Garland, TX, 75043, US

(21) Appl. No.: 09/900,821

(22) Filed: Jul. 6, 2001

(51) Int. Cl. G10L 21/06; G10L 11/00

(52) U.S. Cl. 704/276

(57) ABSTRACT

Mark R. Haley has created software which uniquely converts text from any language into realistically sounding human speech in any language on any device such as off-the self computers (or servers) and it has the option to show related videos and photos (or any multimedia) which is associated with that text.

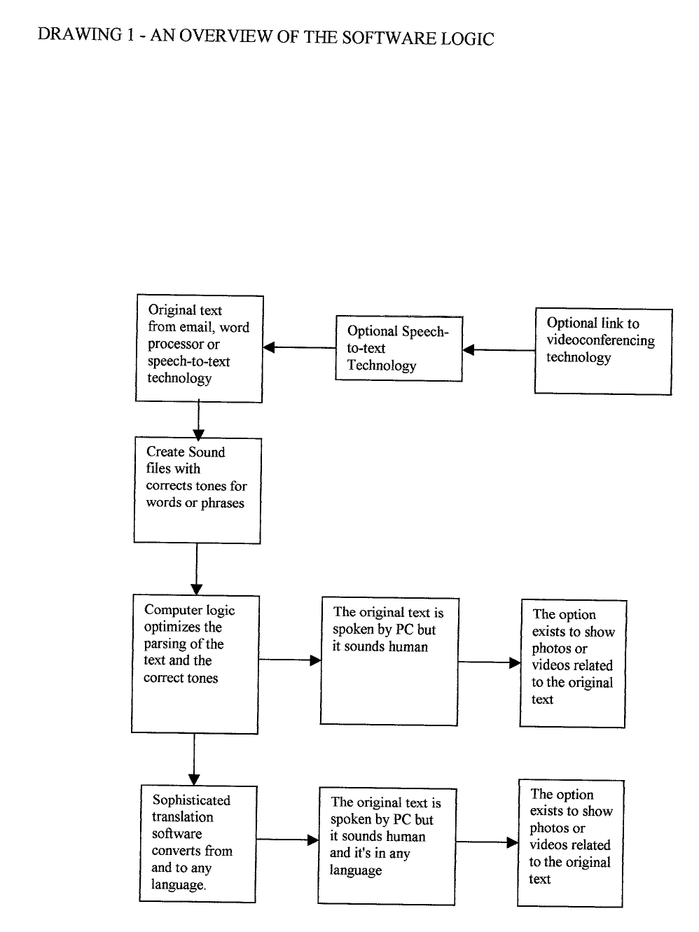

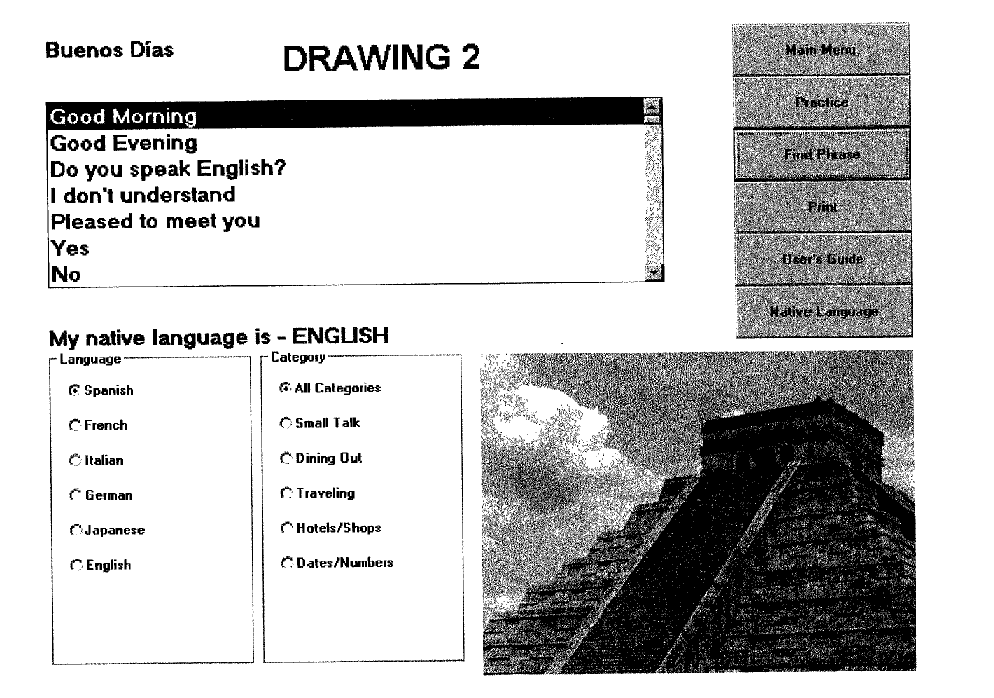

### CROSS-REFERENCE TO RELATED APPLICATIONS

Follow up to the Provisional application (No. 60/217,938) for Patent filed on Jul. 13, 2000.

### STATEMENT REGARDING FEDERALLY SPONSORED RESEARCH OR DEVELOPMENT

Mark R. Haley has worked on various projects, some of which included Federal funding over the last 18 years, all of these were with the company Analytical Software Inc. and these contracts permitted our company, Analytical Software Inc., and Mark R. Haley to keep all rights to inventions. Moreover, an agreement between Mark R. Haley and Analytical Software Inc. permits Mark R. Haley to retain the copyrights and all patents for any work he has performed at Analytical Software Inc. While Analytical Software Inc. may temporarily hold title to copyrights and patents which Mark R. Haley has created, Mr. Haley can at any time transfer title of these back to his name at any time at his sole discretion. Mr. Haley has performed all of the software coding and the work on this patent and any related copyrights.

### REFERENCE TO A MICROFICHE APPENDIX

While no computer program listing will be provided at this time as noted in the specification above, these could be provided to demonstrate the uniqueness of this invention.

### BACKGROUND OF THE INVENTION

The Wall Street Journal on Jun. 30, 2000, described the state-of-the-art of text to voice technology as like “hearing a ‘Drunken Robot’”. Moreover, this technology often requires special hardware or software which only works on powerful servers. The invention by Mark R. Haley, sounds like a human. It works on both servers and client computers (but it is not limited to PCs, since it will work on any existing or future devices such as Palm PCs, cellular phones, TVs, telephones or any device which can carry speech, pictures, or videos or multimedia). Therefore it will serve the mass market and it can simultaneously translate the text from any language (such as but not limited to English, French, Italian, German, Japanese, Chinese, Latin or even recently-created languages such as those based on TV shows and movies) into any language (such as but not limited to those just listed, i.e. English, French, Italian, German, Japanese, Chinese, Latin. etc.) and clearly speak that language in a human sounding voice and also simultaneously show related videos or photos or other multimedia. While the following example is not a requirement of this invention it illustrates the uniqueness of this invention. It will permit an off-the-shelf PC to perform text-to-speech, to simultaneously translate this into any language and to have the PC speak this text in any language and to show related multimedia all without any special hardware and using computer code of less than one megabyte. And the computer generated speech of this new invention sounds like a human and not a ‘Drunken Robot’ as existing technology. In addition, when linked to speech-to-text technology, this could provide two-way real-time videoconferencing with translation. To demonstrate the uniqueness of this invention a demo could be provided.

The current state-of-the-art is represented by patents developed by Lucent Technologies which offer sophisticated complex accenting, intonation, and speech synthesis technologies to create text-to-speech. Unfortunately, as noted in the Wall Street Journal articles, these technologies don't sound very good—they sound too much like a computer because of too much speech synthesis. Mr. Haley's technology relies on optimal recording of the original voices with minimal refining of this data to insure that the speech sounds as human as possible. While solutions like Lucent's are impressive, because the original speech is manipulated using extensive signal processing, the clarity of the original voice is distorted. Mr. Haley's solution uses the statistical techniques and parsing of the original human spoken words or phrases to retain the original clarity. For example, while other text-to-speech may completely modulate the original digital signal to convert a man's voice to different sounding men's voices, Mr. Haley's technique preserves the original speaker's voice, but may modulate the volume or emphasis based on statistical samples to insure the correct emphasis based on the most used phrases or words. The net result is that his text-to-speech solution sounds as good or better than the Lucent technology using an entirely different approach and it runs on many more platforms.

Mark R. Haley has developed this capability over an 18 year period and this invention is a unique combination of these skills into a unique invention. Moreover, if the patent office fails to approve this patent, then any other patent claiming these technologies would have to be voided since Mark R. Haley has been using these series of technologies in CD-ROMs and messaging systems for over 18 years which he is combining into a unique invention.

### BRIEF SUMMARY OF THE INVENTION

As noted above, this invention provides a unique state-of-the-art of text to multimedia capability including voice, translation to other languages and simultaneously showing related videos and photos using off-the-shelf computers. The invention by Mark R. Haley works on both servers and client computers so it serves the mass market.

### BRIEF DESCRIPTION OF THE SEVERAL VIEWS OF THE DRAWINGS

There are two drawings. Drawing 1 is a simple drawing which is a flow chart of the logic in this invention. Several views are not on this flow chart. This flow chart (or drawing) simply shows that text can be converted to human voice or translated using this technology. Also, if the text-to-speech technology is combined with speech-to-text technology then it can be used for real-time videoconferencing with voice-to-voice translation from any language into any other language.

Drawing 2 illustrates a universal translator which converts between any languages and when combined with the text to speech technology allows the user to both see the text and hear the spoken words in both the user's native language and the language the user is learning. This powerful technology allows the user to speak any language, and it could be used on a computer or a cell phone. When used with speech to text technology the user could speak into the computer or cell phone and then the user could hear this spoken in any language instantaneously.

### DETAILED DESCRIPTION OF THE INVENTION

While text-to-speech software has existed for a number of years, it has either required special hardware or powerful computers. Moreover, the quality of the speech has been poor. Also, it does not usually provide simultaneous translation and speech into any language, nor does it provides simultaneous showing of related multimedia, such as videos and photos, and also operate on an off-the-shelf PC. In short, the state-of-the-art today is cumbersome, computer intensive, and lacks multimedia features for an off-the-shelf PC. The invention by Mark R. Haley is unique because it overcomes these limitations. Moreover, as noted above, this invention will work in any language and on any device which carries speech, videos, pictures, or any form of multimedia, such as but not limited to phones, TVs, PCs, handheld computers, etc, which may exist now or in the future.

There are three parts to this invention:

Part One—The recording and combination of the speech. Each word or group of words must be recorded with the correct tones to make the speech sound realistic. Moreover, the software must combine the speech to make it sound human. Finally, the size of the vocabulary must be statistically minimized to insure that it works on the most common PCs, and not just powerful servers. Also, the integrity and clarity of the original human voice must be maintained by using statistical techniques to identify the most used words and phrases and record these and combine these to preserve the original quality of the voice without using digital signal processing techniques which excessively distort the original voice.

The core of the logic of the text to speech technology is described below and no computer code is needed since this core logic could be used in whatever programming language is used.

(1) Use statistical sampling to identify the most common words and then determine the available storage space available. If only 20 MB of space were available the goal would be to use non-synthesize speech were possible and then use synthesized speech for words which could not fit in the desired space (i.e. 20 MB). Moreover synthesized speech would also be used to add emphasis, and intonation to the non-synthesized words. The net result would be the most human sounding voice with a mixture of some synthesized speech to add intonation and emphasis and to also pronounce words which could not fit in the dictionary due to space constraints. For example, if there were only 20 MB of space and the synthesized code took 6 MB, then this would only leave 14 MB for the non-synthesized words. If each compressed word was only 3 KB this would mean the non-synthesized words would number less than 5,000 and the rest of the words would need to be synthesized (Space available/average size for each non-synthesized words equals the number of non-synthesized words).

(2) After the number of non-synthesized words is determined, then the text must be parsed. Usually the non-synthesized words would be used, while the synthesized words would fill in the gaps and add emphasis to the speech. The net result would be the most human sounding text to speech technology. Drawing 1 illustrates how this technology would be enhanced for a broad range of applications.

(3) In addition, this technology could be combined with the capabilities shown in Drawing 2 to greatly enhance the usefulness of this text to speech engine. With the added translation capabilities, and speech to text technology, Drawing 2 illustrates how this software could be used on computers or cell phones. For example, the user could speak in one language and have the text shown both in their native language and the language they want to speak, and the software would speak in both languages. Or the user could selected the desired phrase in their native language and then hear it spoken in both their native language and the language they want to hear. Or the user could type in the text in their native language and then hear the language they want to learn.

In all these cases the software would show text and speak in both the user's native language and the language the user wanted to speak or learn. These are a few methods on how the technology could work on cell phones or computers. Of course any combination of these options would be available to the user.

Part Two—Translation. The software may have additional options and logic to translate the text from any language into any other language and then make the computer generated speech sound human using the same logic as in Part One. Drawing 2 illustrates how multiple languages can be easily translated. The input to these languages could be a number of methods, such as but not limited to the following. For example, the user could select a list of standard phrases which are translated into any language. Or the user could type in free form text which is translated and then with text to speech technology is spoken. Or the user could just speak and with speech to text technology it would convert it to text and show the text both in the user's native language and the targeted translated language. Then it would speak both the user's native language and the language the user wants to learn or speak. Drawing 2 is only a sample illustration of how this could appear on a screen. The screen could be a computer monitor or a more concise version could be modified for a cell phone.

Part Three—Related Multimedia. The software must have the option to show related videos or photos that correspond to the text.

Part Four—Real-time Translation with optional Videoconferencing—If this text-to-speech technology is linked with a speech-to-text system then there would be real-time voice-to-voice translation—as one person speaks in one language, the computer speaks in a second language. And if also combined with videoconferencing technology this would provide real-time voice-to-voice translation with videoconferencing.

Mark R. Haley has created computer code which meets these requirements and correct recording techniques to insure that the resulting text-to-speech: (1) sounds realistic, (2) that it operates on off-the-shelf PCs or any other devices which can carry human voice or multimedia (3) that it simultaneously translates the text, (4) that it simultaneously shows related multimedia, and (5) that when combined with voice recognition technology (or speech-to-text) it provides the option for real-time voice-to-voice translation which could include videoconferencing options.

What I, Mark R. Haley, claim as my invention is:

1) claim one is a unique combination of recording techniques and software that lets a computer talk and sound like a human and not a computer. This text-to-speech works on any device which carries speech or multimedia and it runs on both client PCs and servers. But it is unique in that it only requires the power of an off-the-shelf PC or computer device or other device which can carry speak such as a phone. Moreover it also has the option to translate the text from any language into any language and the computer speaks realistically in any language. Also, it has the option to simultaneously show related photos or videos that correspond to the original text which is converted to speech.
